(19) United States
(12) Patent Application Publication
(10) Pub. No.: US 2015/0102996 A1
(43) Pub. Date: Apr. 16, 2015

(54) DISPLAY APPARATUS AND POWER-SAVING PROCESSING METHOD THEREOF

(71) Applicant: SAMSUNG ELECTRONICS CO., LTD., Suwon-si (KR)

(72) Inventors: Dale YIM, Suwon-si (KR); You-young JUNG, Yongin-si (KR)

(73) Assignee: SAMSUNG ELECTRONICS CO., LTD., Suwon-si (KR)

(21) Appl. No.: 14/230,035

(22) Filed: Mar. 31, 2014

(30) Foreign Application Priority Data
Oct. 10, 2013 (KR) 10-2013-0120598

(51) Int. Cl. G06F 3/01

(52) U.S. Cl. CPC G06F 3/012; G09G 2330/021
USPC 345/156

(57) ABSTRACT

A power-saving processing method and the display apparatus are provided. The method includes sensing an external environment of the display apparatus, determining a level of viewing concentration based on a result of the sensing, and displaying content by performing a power-saving processing operation at a level corresponding to the level of viewing concentration among a plurality of levels of the power-saving processing operation.

### CROSS-REFERENCE TO RELATED APPLICATION

This application claims priority from Korean Patent Application No. 10-2013-0120598, filed on Oct. 10, 2013, in the Korean Intellectual Property Office, the disclosure of which is incorporated herein by reference in its entirety.

### BACKGROUND

1. Field

Apparatuses and methods consistent with exemplary embodiments relate to a display apparatus and a power-saving processing method thereof, and more particularly, to a display apparatus capable of sensing an external environment thereof and performing a power-saving processing operation, and a power-saving processing method thereof.

2. Description of the Related Art

With the development of electronic technology, various types of electronic devices have been developed and distributed. With the distribution of high-definition content, a viewer may watch the high-definition content even in small-scale display apparatuses such as smart phones or tablet personal computers (PCs) as well as large-scale display apparatuses such as televisions (TVs).

In particular, when large scale and high definition display apparatuses are used in homes, electric power consumption is increased. Therefore, the viewer may want to reduce power consumption by selectively watching high-definition image content depending on a viewer's taste. Accordingly, a quality mode may be controllable by the viewer in recently developed display apparatuses.

However, it is difficult and cumbersome for the viewer to change quality of image content by controlling the quality mode using, for example, a set-up menu.

Therefore, there is a need for technology capable of efficiently setting quality of displayed image content according to a state of a viewer and a viewing environment.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a display apparatus capable of performing a power-saving processing operation by determining a level of viewing concentration of a viewer based on an external environment, and a power-saving processing method thereof.

According to an aspect of an exemplary embodiment, there is provided a power-saving processing method. The method may include: sensing an external environment of the display apparatus; determining a level of viewing concentration based on a result of the sensing; and displaying content by performing a power-saving processing operation at a level corresponding to the level of viewing concentration among a plurality of levels of the power-saving processing operation.

The sensing may include imaging a viewer of the display apparatus. The level of viewing concentration may be determined based on an imaged image of the viewer.

The determining may include determining a viewing posture of the viewer based on the imaged image of the viewer; and determining the level of viewing concentration corresponding to the determined viewing posture of the viewer based on a plurality of pre-imaged images and information of a plurality of levels of viewing concentration set to match the plurality of images, respectively.

The determining may include determining an eye direction of the viewer based on the imaged image of the viewer; calculating a direction of a location of the viewer relative to the display apparatus; and comparing the eye direction with the direction of the location of the viewer and determining the level of viewing concentration according to a result of the comparison.

The determining may include calculating levels of viewing concentration of a plurality of viewers when the plurality of viewers are sensed; and determining a total level of viewing concentration based on a number of viewers having levels of viewing concentration equal to or larger than a preset threshold value.

The sensing may include sensing a plurality of items of the external environment. The determining may include acquiring sensing results of the plurality of items; correcting the sensing results of the plurality of items by applying preset weights for the plurality of items to the sensing results; and determining the level of viewing concentration based on the corrected sensing results.

The plurality of items may include at least one from among an ambient temperature of the display apparatus, an ambient humidity of the display apparatus, a luminance, a viewing distance, a viewing time zone, a number of viewers, an eye direction of the viewer, and a viewing posture of the viewer.

The plurality of power-saving processing operation may include at least one from among an operation of performing display-off of an image frame in every preset period, an operation of turning off a super-resolution mode, an operation of reducing a luminance, an operation of reducing a size of a display area of the content, and an operation of turning on and/or off a display of the display apparatus.

The displaying may include controlling a display-off period of an image frame of the content according to the level of the viewing concentration.

According to an aspect of an exemplary embodiment, there is provided a display apparatus. The display apparatus may include: a display configured to display content; a sensor configured to sense an external environment of the display apparatus; and a controller configured to determine a level of viewing concentration based on a result of the sensing, and control the display to display the content by performing a power-saving processing operation at a level corresponding to the level of viewing concentration among a plurality of levels of the power-saving processing operation.

The sensor may include a photographing unit configured to image a viewer of the display apparatus. The controller may determine the level of viewing concentration based on an image of the viewer imaged through the photographing unit.

The display apparatus may further include a storage. The controller may determine a viewing posture of the viewer based on the imaged image of the viewer, and determine the level of viewing concentration corresponding to the determined viewing posture of the viewer based on a plurality of pre-imaged images stored in the storage and information of a plurality of levels of viewing concentration set to match the plurality of images, respectively.

The controller may determine an eye direction of the viewer based on the imaged image of the viewer, calculate a direction of a location of the viewer relative to the display apparatus, compare the eye direction with the direction of the location of the viewer, and determine the level of viewing concentration according to a result of the comparison.

The controller may calculate levels of viewing concentration of a plurality of viewers when the plurality of viewers are sensed, and determine a total level of viewing concentration based on a number of viewers having levels of viewing concentration equal to or larger than a preset threshold value.

The sensing may sense a plurality of items of the external environment. The controller may acquire sensing results of the plurality of items, correct the sensing results of the plurality of items by applying preset weights for the plurality of items to the sensing results, and determine the level of viewing concentration based on the corrected sensing results.

The plurality of items may include at least one from among an ambient temperature of the display apparatus, an ambient humidity of the display apparatus, a luminance, a viewing distance of the viewer, a viewing time zone, a number of viewers, an eye direction of the viewer, and a viewing posture of the viewer.

The controller may perform the power-saving processing operation by performing at least one from among an operation of performing display-off of an image frame in every preset period, an operation of turning off a super-resolution mode, an operation of reducing a luminance, an operation of reducing a size of a display area of the content, and an operation of turning on and/or off the display of the display apparatus.

The controller may control a display-off period of an image frame of the content according to the level of the viewing concentration.

### BRIEF DESCRIPTION OF THE DRAWINGS

The above and/or other aspects will be more apparent by describing in detail exemplary embodiments, with reference to the accompanying drawings, in which:

FIG. 1 is a block diagram illustrating a configuration of a display apparatus according to an exemplary embodiment;

FIG. 2 is a detailed block diagram illustrating a configuration of a display apparatus according to an exemplary embodiment;

FIGS. 3 to 5 are views illustrating various examples in which a display apparatus images a viewer;

FIG. 6 is a view explaining an example of a method of analyzing an imaged image;

FIGS. 7 to 10 are views illustrating pre-imaged images of a viewer according to various exemplary embodiments;

FIG. 11 is a view illustrating an example in which a display apparatus images eyeballs of a viewer according to an exemplary embodiment;

FIG. 12 is a view illustrating an example in which a viewer watches content displayed on a display apparatus;

FIG. 13 is a view illustrating an example in which a display-off operation of an image frame is performed every preset period according to an exemplary embodiment; and

FIG. 14 is a flowchart illustrating a power-saving processing method according to an exemplary embodiment.

### DETAILED DESCRIPTION

Hereinafter, exemplary embodiments will be described in more detail with reference to the accompanying drawings.

In the following description, the same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

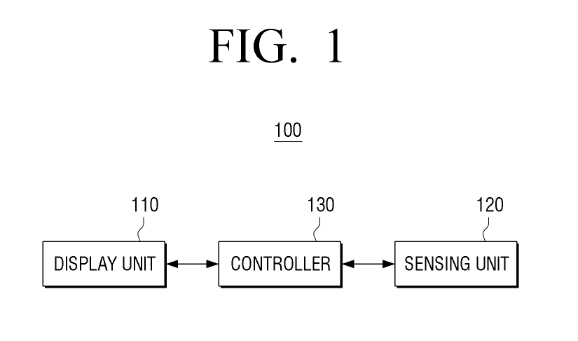

FIG. 1 is a block diagram illustrating a configuration of a display apparatus 100 according to an exemplary embodiment. As illustrated in FIG. 1, the display apparatus 100 includes a display unit (e.g., display) 110, a sensor unit (e.g., sensor) 120, and a controller 130. The display apparatus 100 may be a television (TV), but this is merely exemplary. The display apparatus 100 may be implemented with various electronic apparatuses including the display unit 110, such as a portable phone, a tablet personal computer (PC), a digital camera, a camcorder, a laptop PC, or a personal digital assistant (PDA).

The display unit 110 displays content. The display unit 110 may display, for example, image content including broadcasting content. The display unit 110 may display an image with a super-resolution mode according to a setting of a viewer. The display unit 110 may display content on which a power-saving processing operation is performed according to a setting of the viewer or control of the controller 130.

The sensor unit 120 senses an external environment of the display apparatus 100. The sensing unit 120 may sense, for example, an external temperature, humidity, or luminance of the external environment of the display apparatus 100. Also, the sensing unit 120 may sense the number of viewers who watch the display apparatus 100, a posture of the viewer, or the like.

The controller 130 may control image content displayed on the display unit 110. That is, the controller 130 may determine a level of viewing concentration based on a sensing result of the external environment sensed by the sensing unit 120. The controller 130 may control the display unit 110 to display the content by performing the power-saving processing operation at a level corresponding to the level of viewing concentration among a plurality of power-saving processing operation levels determined according to a power-saving effect. The controller 130 may include a processor, a microprocessor, a central processing unit (CPU), or an integrated circuit for executing programmable instructions.

That is, when the sensing unit 120 senses the external environment, the controller 130 determines the level of viewing concentration of the viewer based on the sensing result.

The level of viewing concentration means a degree in which the viewer concentrates on the content, e.g., image content, displayed on the display apparatus 100. The level of viewing concentration may be determined by various methods according to exemplary embodiments.

For example, the display apparatus 100 may image the viewer, analyze a viewing distance, the number of viewers, an eye direction of the viewer, a viewing posture, or the like based on the imaged image, and determine the level of viewing concentration based on an analysis result. Alternatively, the display apparatus 100 may sense an indoor temperature, an ambient temperature, humidity, luminance, or the like, and determine the level of viewing concentration based on a sensing result. Further, the display apparatus 100 may determine the level of viewing concentration based on a viewing time, a viewing area, a kind of content, or the like.

For example, when the sensing unit 120 senses that the viewer stares in a direction toward a front portion of the display unit 110 in a state in which an appropriate (e.g., optimal) indoor temperature and optimal indoor humidity are maintained, the controller 130 may determine that the level of viewing concentration is higher.

When the sensing unit 120 senses that the optimal indoor temperature and the optimal indoor humidity are not maintained, and the viewer does not stare in the direction toward the front portion of the display unit 110, the controller 130 may determine that the level of viewing concentration is lower.

The level of viewing concentration may be represented with a number having a value from, for example, 1 to 100, and the controller 130 may determine that the level of viewing concentration is increased as the number is increased.

The controller 130 controls to perform the power-saving processing operation at a level corresponding to the degree of viewing concentration, among the plurality of power-saving processing operation levels. That is, the power-saving processing operation may be divided into a plurality of levels according to the power-saving effect. For example, the power-saving processing operation may be divided into three levels of “power-saving effect High”, “power-saving effect Medium”, and “power-saving effect Low”. When it is determined that the level of viewing concentration is higher, the controller 130 may control to perform the power-saving processing operation corresponding to the level of “power-saving effect Low”. When it is determined that the level of viewing concentration is lower, the controller 130 may control to perform the power-saving processing operation corresponding to the level of “power-saving effect High”.

Further, in the level of “power-saving effect High”, the controller 130 may control the super-resolution mode to be turned off and simultaneously control a frame of image content displayed on the display unit 110 to be displayed off, for example, in every 10 frame period. The controller 130 may also control luminance of the display apparatus 100 to be reduced. In the level of “power-saving effect Low”, the controller 130 may only control a frame of the image content displayed on the display unit 110 to be displayed off, for example, in every 20 frame period.

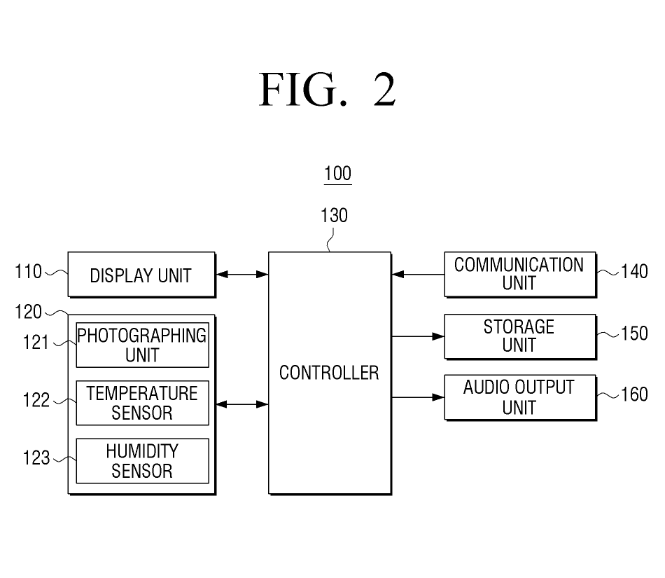

Hereinafter, a configuration of the display apparatus 100 according to an exemplary embodiment will be described in detail with reference to FIG. 2.

As illustrated in FIG. 2, the display apparatus 100 includes a display unit 110, a sensing unit 120, a controller 130, a communication unit (e.g., communicator) 140, a storage unit (e.g., storage) 150, and an audio output unit 160.

As shown in FIG. 2, by using various components, the display apparatus 100 may have various functions such as a display function, a communication function, a voice recognition function, a level of viewing concentration determination function, or a power-saving processing function. It should be noted that the above components are merely given as examples and various components may be added, modified, omitted, or combined.

The display unit 110 may display content. The display unit 110 may display image content including broadcasting content. That is, the display unit 110 may display image data received from various sources such as external broadcasting stations through an image receiver (not shown).

The display unit 110 may display an image of the super-resolution mode according to a setting of a viewer. The display unit 110 may display content on which the power-saving processing operation is performed according to a setting of the viewer or control of the controller 130.

The sensor unit 120 may sense an external environment of the display apparatus 100. The exemplary embodiment of FIG. 2 illustrates that the sensor unit 120 is implemented with a configuration including a photographing unit 121, a temperature sensor 122, and a humidity sensor 123 to detect, for example, an external temperature, humidity, a state of a viewer, or the like. However, as described above, the external environment may include various items, and thus the configuration of the sensing unit 120 may be variously modified according to the items of the external environment.

The photographing unit 121 may image the viewer. That is, the photographing unit 121 may image the viewer according to the setting of the viewer, and the photographing unit 121 may image the viewer, for example, in every preset period. According to an exemplary embodiment, the photographing unit 121 may be implemented in a camera module for photographing an image.

The temperature sensor 122 may sense a temperature around the display apparatus 100. The humidity sensor 123 may sense humidity around the display apparatus 100. The controller 130 may determine a level of viewing concentration based on at least one of the temperature and humidity around the display apparatus 100 sensed by the temperature sensor 122 and the humidity sensor 123, respectively.

That is, when the viewer concentrates on watching the display apparatus 100, an optimal temperature and an optimal humidity adequate for a general viewer's age may be maintained. Therefore, when the temperature sensor 122 and the humidity sensor 123 sense the appropriate temperature and humidity, respectively, the controller 130 may determine that the level of viewing concentration is higher.

The display apparatus 100 may not include the temperature sensor 122 and the humidity sensor 123. When the display apparatus 100 may not include the temperature sensor 122 and the humidity sensor 123, the controller 130 may receive information related to the temperature and/or humidity from external devices through the communication unit 140. At this time, the controller 130 may determine the level of viewing concentration based on the received information or the temperature and/or humidity.

The communication unit 140 is configured to perform communication with various types of external apparatuses according to various types of communication methods. The communication unit 140 may include, for example, a wireless fidelity (WIFI) chip, a Bluetooth chip, or a wireless communication chip, or a near field communication (NFC) chip.

The WIFI chip and the Bluetooth chip may be used to perform communication in a WIFI manner and a Bluetooth manner, respectively. When the WIFI chip or the Bluetooth chip is used, the communication unit 140 may first transmit and/or receive a variety of connection information such as a service set identifier (SSID) and a session key, connect communication using the connection information, and transmit and/or receive a variety of information. The wireless communication chip is a chip configured to perform communication according to various communication standards, such as Institute of Electrical and Electronics Engineers (IEEE), Zigbee, 3rd generation (3G), 3rd Generation Partnership Project (3GPP), or Long Term Evolution (LTE). The NFC chip is a chip configured to operate in the NFC manner using a band of 13.56 MHz among various radio frequency identification (RF-ID) frequency bands such as 135 kHz, 13.56 MHz, 433 MHz, 860 to 960 MHz, and 2.45 GHz.

The storage unit 150 may store an image of a viewer. In an exemplary embodiment, the storage unit 150 may store the image of the viewer imaged through the photographing unit 121. Alternatively, the storage unit 150 may receive a pre-imaged image of the viewer through the communication unit 140 and store the pre-imaged image of the viewer. The storage unit 150 may include a memory.

Further, the storage unit 150 may store a variety of settings for determining the level of viewing concentration and performing the power-saving processing operation.

Therefore, when the viewer does not set to perform the power-saving processing operation in real time, the controller 130 may determine the level of viewing concentration according to the setting pre-stored in the storage unit 150, and perform the power-saving processing operation.

The audio output unit 160 may output audio data. That is, an audio processor (not shown) of the display apparatus 100 may perform processing on audio data. The audio processor may perform a variety of processing such as decoding or amplification of the audio data or noise filtering. Therefore, the audio output unit 160 may output audio data processed by the audio processor. For example, the audio output unit 160 may include a speaker.

By using the display apparatus according to an exemplary embodiment as described above, the viewer may watch image content on which a power-saving operation is performed according to the level of viewing concentration.

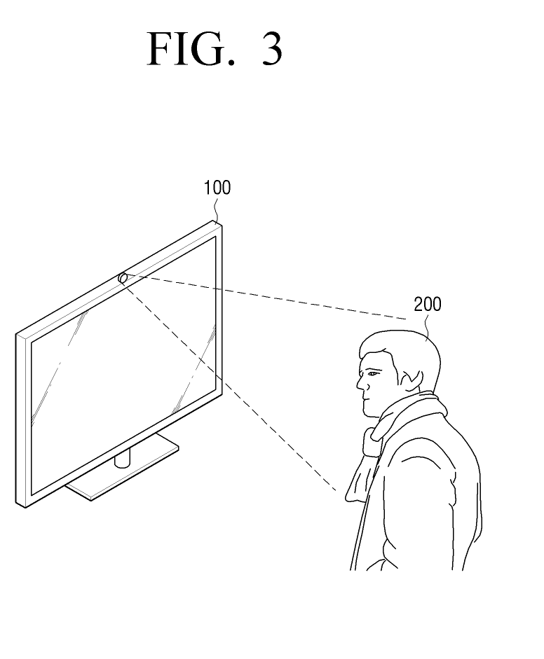

FIGS. 3 to 5 are views illustrating various examples in which the display apparatus 100 images a viewer.

As illustrated in FIGS. 3 to 5, the photographing unit 121 may image a viewer 200, and the controller 130 may determine a level of viewing concentration based on the image of the viewer 200 imaged through the photographing unit 121.

For example, when the photographing unit 121 images a front of the viewer 200 as illustrated in FIG. 3, the controller 130 may determine that the level of viewing concentration is higher.

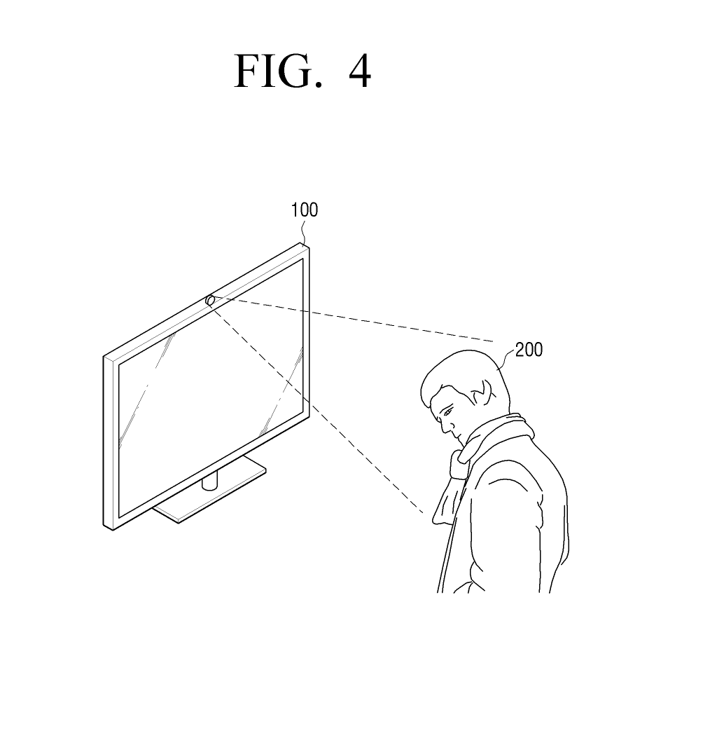

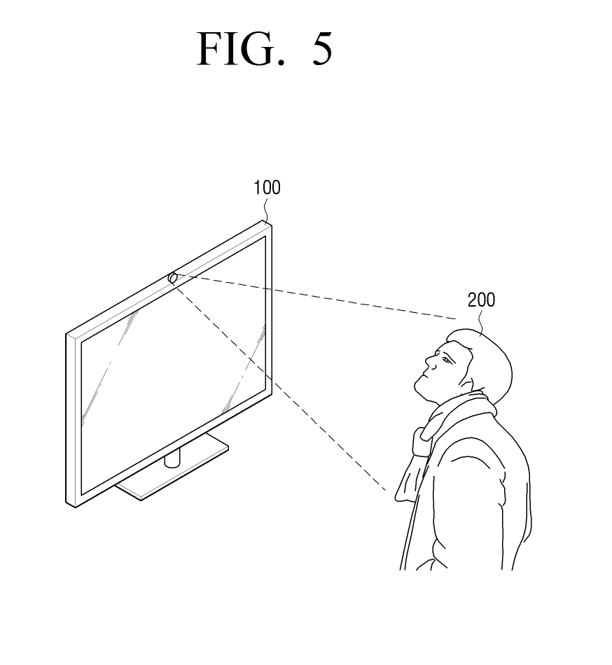

When the photographing unit 121 images a figure in which the viewer 200 bows his/her head or the viewer 200 tilts his/her head back as illustrated in FIG. 4 or 5, the controller 130 may determine that the level of viewing concentration is lower since the eyes of the viewer 200 are not directed to the display unit 110.

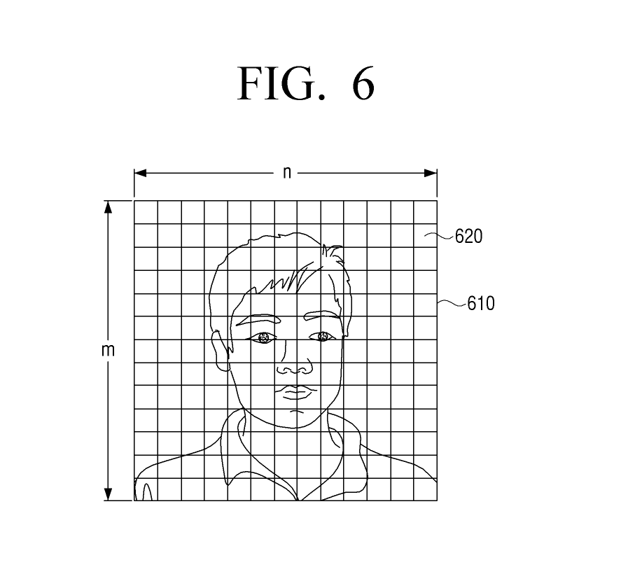

A method of analyzing the imaged image of the photographing unit 121 will be described in detail with reference to FIG. 6. Referring to FIG. 6, the controller 130 divides an image 610 imaged by the photographing unit 121 into a plurality of blocks 620 defined along a horizontal direction and a vertical direction. For example, as shown in FIG. 6, the plurality of blocks may include n×m blocks. Each block 620 may include a plurality of pixels. The controller 130 detects attribute values of the pixels included in each block 620, and compares the attribute values of a block with attribute values of adjacent blocks to determine whether or not the block is a block constituting the same object as the adjacent blocks. The controller 130 performs a determination process for each block 620 to detect an edge portion of an object of the image 610. Accordingly, the controller 130 may detect a face region, an eyeball region, an iris region, etc. The controller 130 may also detect coordinates of the center of an iris of the viewer 200 by considering a color, a shape, a size, or the like of regions divided according to edge portions of the object. Various algorisms and models may be applied to the detection process.

As an example, the controller 130 may use an optimal attention concentration model with respect to the image of the viewer 200. For example, the controller 130 may detect a face region by applying a saliency map (SM) model. The controller 130 may detect an eyeball region from the detected face region using an adaBoost algorithm, and detect a pupil region from the detected eyeball region. The controller 130 may detect coordinates of the center of the detected pupil, and map locations of the coordinates of the center to a screen displayed on the display unit 110. Therefore, the controller 130 may determine whether the coordinates of the center of the pupil is directed to the screen, e.g., a certain point of the screen. The eye-tracking algorithms are well known in the art, and thus detailed description thereof will be omitted.

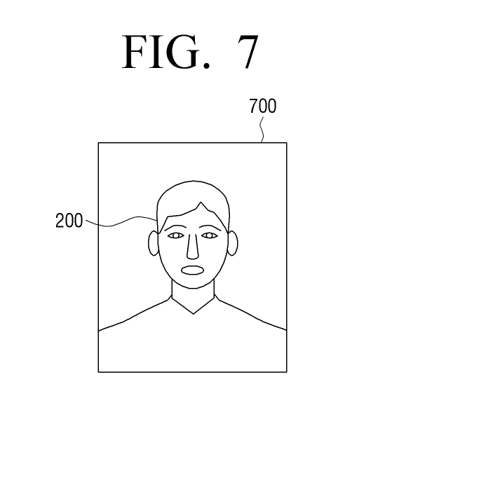

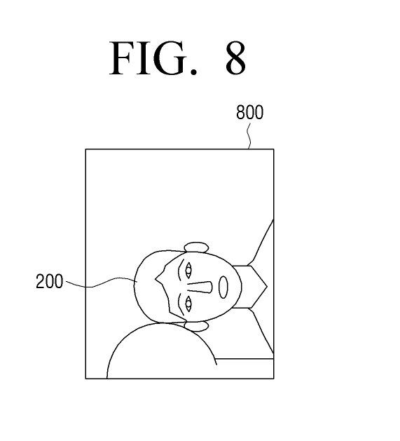

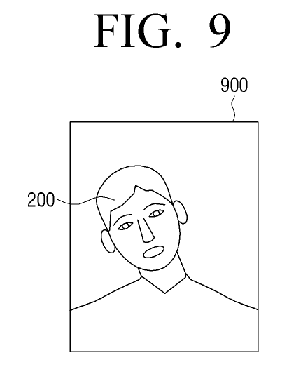

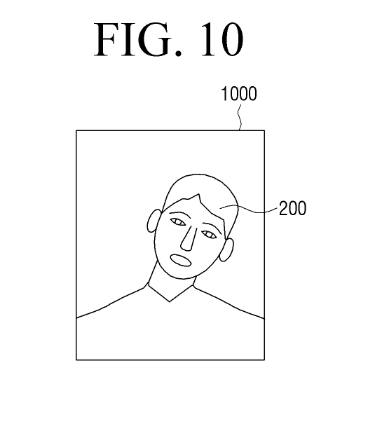

As illustrated in FIGS. 7 to 10, the controller 130 may determine the level of viewing concentration using a plurality of pre-imaged images stored in the storage unit 150. That is, the controller 130 may analyze the imaged image of the viewer 200 to determine a viewing posture of the viewer 200, detect information of the level of viewing concentration corresponding to the viewing posture of the viewer 200, and determine the level of viewing concentration according to a detection result. For example, to analyze the imaged image of the viewer 200, the controller 130 may refer to a plurality of pre-imaged images stored in the storage unit 150 and information of respective levels of viewing concentration set to match the plurality of pre-imaged images.

Specifically, the storage unit 150 may store at least one image of a viewer 200 imaged through the photographing unit 121. For example, the storage unit 150 may store four images 700, 800, 900, and 1000 of the viewer 200 as illustrated in FIGS. 7 to 10.

While the display unit 110 displays image content, the photographing unit 121 may image the viewer 200 in a preset period. The controller 130 may compare the image of the viewer 200 imaged in the preset period with the image of the viewer 200 pre-stored in the storage unit 150. The controller 130 may determine that the level of viewing concentration is higher when the image of the viewer 200 imaged in the preset period is similar to one of the pre-stored images of the viewer 200 illustrated in FIGS. 7 to 10. It should be noted that the viewer 200 of which imaged image is analyzed by the controller 130 may be the same person or a different person from the viewer 200 of which pre-stored images are stored in the storage unit 150.

Further, while the display unit 110 displays the image content, the controller 130 may determine that the level of viewing concentration is lower when the image of the viewer image in the preset period is not similar to the images of the viewer pre-stored in the storage unit 150.

For example, when the imaged image of the viewer is analyzed to be substantially similar to one of the pre-stored four images of FIGS. 7 to 10, the controller 130 may determine that the level of viewing concentration is higher. When the imaged image of the viewer is analyzed to be about 70% similar or more to one of the pre-stored four images, the controller 130 may determine that the level of viewing concentration is medium. When the imaged image of the viewer is analyzed not to be about 70% similar to the pre-stored four images, the controller 130 may determine that the level of viewing concentration is lower.

When the level of viewing concentration is determined to be lower, the controller 130 may perform a power-saving processing operation set to “power-saving effect High”, and the controller 130 may turn off the super-resolution mode, simultaneously control a frame of the image content to be displayed off, for example, in every 10 frame period, and control luminance to be reduced.

When the level of viewing concentration is determined to be higher, the controller 130 may perform a power-saving processing operation set to “power-saving effect Low”, and the controller 130 may only control the frame of the image content to be displayed off, for example, in every 20 frame period.

The controller 130 may analyze the imaged image of the viewer imaged through the photographing unit 121 to determine an eye direction of the viewer, calculate a direction of a location of the viewer relative to the display apparatus, compare the eye direction and the direction of the location of the viewer, and determine the level of viewing concentration according to a comparison result.

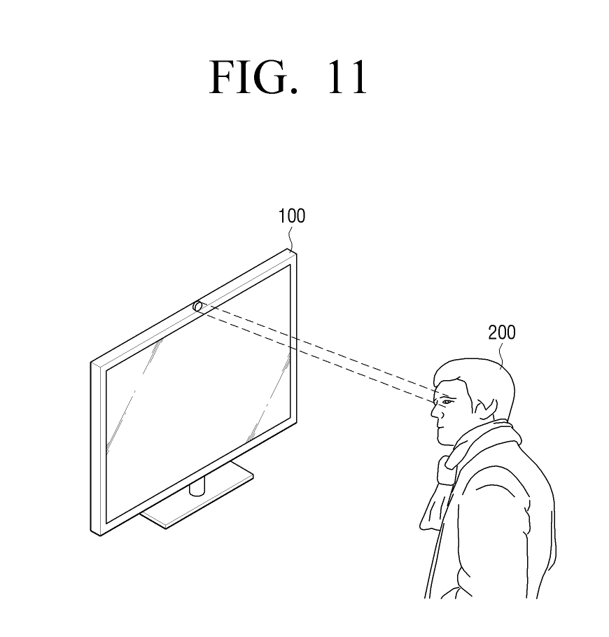

That is, as illustrated in FIG. 11, the photographing unit 121 may image a viewer 200 based on a location of eyeballs of the viewer 200, and the controller 130 may analyze an eye direction of the viewer based on the imaged image of the viewer 200 to determine the level of viewing concentration.

Further, the above-described process of analyzing the imaged image of the viewer to determine the level of viewing concentration may be applied even when a plurality of viewers exist.

For example, when the plurality of viewer are sensed, the controller 130 may calculate respective levels of viewing concentration of the plurality of viewers, and determine a total level of viewing concentration on the basis of the number of viewers having levels of viewing concentration equal to or larger than a preset threshold value.

For example, when it is determined that the plurality of viewers exist in an image imaged through the photographing unit 121, the controller 130 determines a level of viewing concentration for each viewer. The method of determining the level of the viewing concentration may include determining whether or not the image of each viewer coincides with one of the plurality of pre-stored images and determining the level of viewing concentration according to a determination result or comparing the eye direction with the viewing direction and determining the level of viewing concentration according to a comparison result.

When the level of viewing concentration is represented by a number of 1 to 100, the controller 130 may calculate the level of viewing concentration of each viewer, and determine the total level of viewing concentration on the basis of the number of viewers having the levels of viewing concentration equal to or larger than the preset threshold value.

For example, for illustrative purposes, it is assumed that when the level of viewing concentration is equal to or larger than 80, the level of viewing concentration is determined to be higher, and thus the controller 130 performs the power-saving processing operation set to “power-saving effect Low”, when the level of viewing concentration is equal to or larger than 60 and less than 80, the level of viewing concentration is determined to be medium, and thus the controller 130 performs the power-saving processing operation set to “power-saving effect Medium”, and when a level of viewing concentration is less than 60, the level of viewing concentration is determined to be lower, and thus the controller 130 performs the power-saving processing operation set to “power-saving effect High”.

When the controller 130 determines that three viewers exist in an image imaged through the photographing unit 121, and levels of viewing concentration of the three viewers are 85, 85, and 65, respectively, the controller 130 may determine that the total level of viewing concentration is higher since the viewer having the levels of viewing concentration of over 80 are more than half of the viewers, and the controller 130 may perform the power-saving processing operation set to “power-saving effect Low”. It should be noted that this is merely an example and various methods of determining the total level of viewing concentration may be used.

According to an exemplary embodiment, when the external environment is divided into a plurality of items, the controller 130 may acquire respective sensing results for the plurality of items, correct the sensing results for the plurality of items by reflecting preset weights to the sensing results according to the plurality of items, combine the corrected sensing results, and determine the level of viewing concentration according to a combination result.

The plurality of items may include at least one of, for example, an ambient temperature of the display apparatus 100, ambient humidity of the display apparatus 100, luminance, a viewing distance of a viewer, a viewing time zone, the number of viewers, an eye direction of the viewer, and a viewing posture of the viewer.

According to an exemplary embodiment, a weight may be set to an item to be applied when determining the level of viewing concentration according to a default setting or a setting of a user.

For example, when the level of viewing concentration is converted into a numerical value, a weight of 0.5 is reflected to the viewing posture of a viewer, a weight of 0.3 is reflected to the number of viewers, and a weight of 0.2 is reflected to the ambient temperature. The process of determining the level of viewing concentration by using a weight is further described below.

When four pre-stored images are compared with the image of the viewer imaged through the photographing unit 121, and thus it is determined that the image of the viewer imaged through the photographing unit 121 is about 80% similar or more to one of the four pre-stored images, it may be determined that the level of viewing concentration according to the viewing posture of the viewer is 80. When the viewer is one, it may be determined that the level of viewing concentration is lower as compared to when a plurality of viewers exist and that the level of viewing concentration according to the number of viewers is 60. When the ambient temperature sensed through the temperature sensor 122 or received from an external apparatus is in a range of about 20° C. to about 25° C. which is a normal indoor temperature range, it may be determined that the level of viewing concentration according to the ambient temperature is 90.

When the preset weights are reflected to the levels of viewing concentrations for the items, the total level of viewing concentration may be calculated as 80*0.5+60*0.3+90*0.2=76. When the level of viewing concentration is equal to or larger than 60 and less than 80, the controller 130 may perform the power-saving processing operation set to “power-saving effect Medium”.

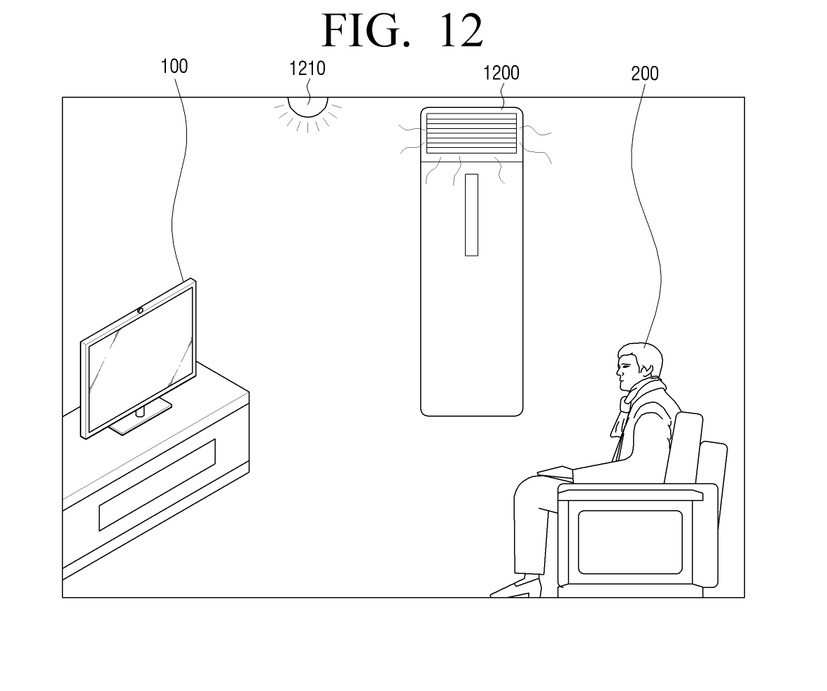

That is, when a viewer receives image content displayed on the display apparatus 100 as illustrated in FIG. 12, the controller 130 may determine a level of viewing concentration by considering various items of the external environment of the display apparatus 100 such as a viewing posture of the viewer 200, the number of viewers 200, luminance controlled by a lamp 1210, and an indoor temperature controlled by an air conditioner 1200.

When the level of viewing concentration is determined, the controller 130 may perform the power-saving processing operation at a level corresponding to the level of viewing concentration, and controls the display unit 110 to display content according to the power-saving processing operation level.

For example, the power-saving processing operation may include at least one of an operation of performing display-off of an image frame every preset period, an operation of turning off the super-resolution mode, an operation of reducing luminance, an operation of reducing a size of a display screen of the content, and an operation of turning on and/or off a display unit of the display apparatus 100.

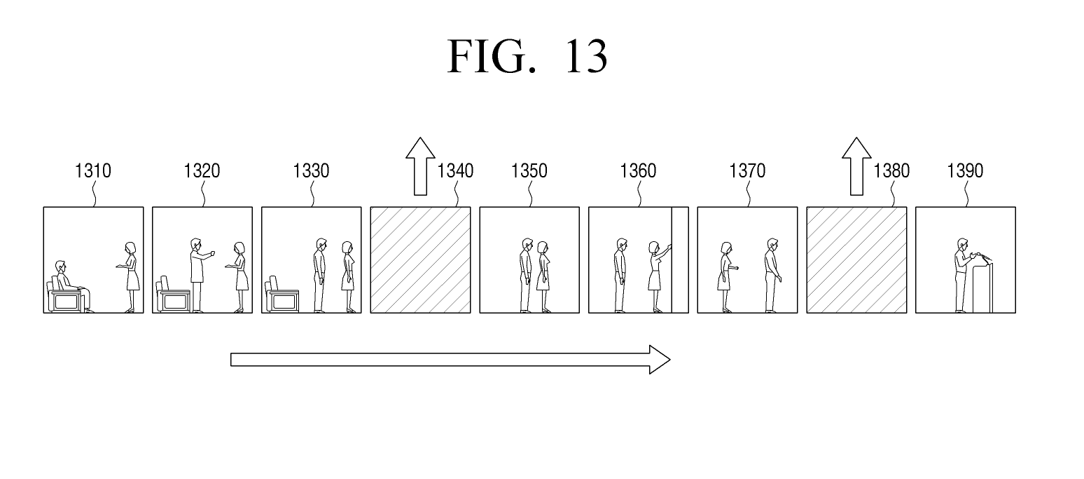

Specifically, the power-saving processing operation may be performed through a display-off operation of an image frame every preset period as illustrated in FIG. 13.

For example, when the power-saving processing is set to “power-saving processing High” by an initial setting of the display apparatus 100 or a setting of a user, the controller 130 may control the display-off operation to be performed every 10th frame of image content. When the power-saving processing is set to “power-saving processing Medium”, the controller 130 may control the display-off operation to be performed every 15th frame of the image content. When the power-saving processing is set to “power-saving processing Low”, the controller 130 may control the display-off operation to be performed every 20th frame of the image content

For example, when the display-off operation is set to be performed every 4th frame of image content, as illustrated in FIG. 13, the controller 130 may sequentially display frames 1310, 1320, and 1330 of the image content, and may perform a display-off operation on an image frame 1340. Next, the controller 130 may sequentially display frames 1350, 1360, and 1370 of the image content and may perform a display-off operation on an image frame 1380.

The controller 130 may control the display-off period of an image frame of content according to the level of viewing concentration.

Therefore, the display apparatus may reduce power consumption by performing the display-off operation of the image frame every preset period as described above.

When a turn-off operation of the super-resolution mode is performed, the controller 130 may control the super-resolution mode to be turned on only when it is determined that the level of viewing concentration is higher, and control the super-resolution mode to be turned off when it is determined that the level of viewing concentration is not higher.

The controller 130 may perform power-saving processing in a predetermined order for the power-saving processing according to an initial setting of the display apparatus 100 or a setting of a user.

For example, the controller 130 may control power-saving processing operations to be sequentially performed according to the levels of viewing concentration. That is, when the level of viewing concentration becomes 80 from 100, the controller 130 may control the super-resolution mode to be turned off, and when the level of viewing concentration becomes 70, the controller 130 may control to perform display-off of an image frame in every 10 frame period. When the level of viewing concentration becomes 60, the controller 130 may control display-off of an image frame in every 20 frame period, and when the level of viewing concentration becomes 50, the controller 130 may control luminance of the display unit 110 to be reduced. When the level of viewing concentration becomes 40, the controller 130 may control a size of a display screen of displayed content to be reduced in half, and when the level of viewing concentration becomes 30, the controller 130 may control power of the display unit 110 to be turned off.

The storage unit 150 may store a setting of an order of the above-described power-saving processing.

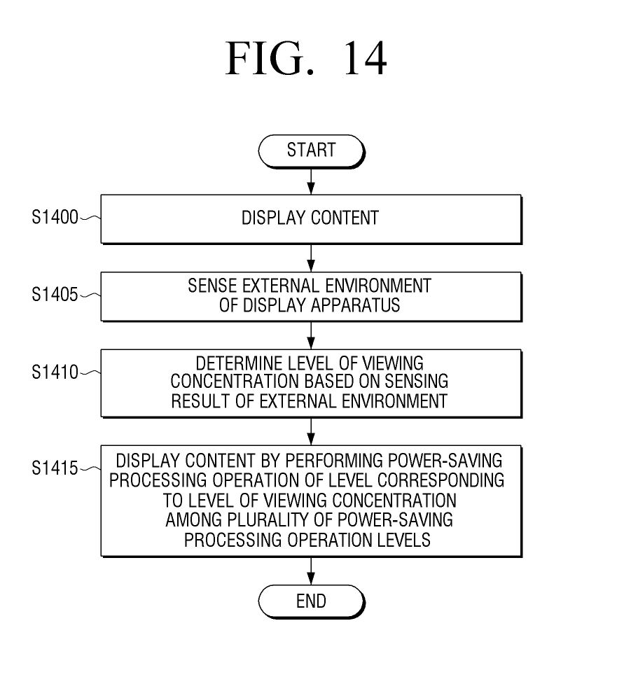

FIG. 14 is a flowchart illustrating a power-saving processing method according to an exemplary embodiment.

First, the display apparatus 100 displays content (S1400), and the display apparatus 100 senses an external environment of the display apparatus (S1405). The external environment may include a plurality of items, and may include at least one of an ambient temperature of the display apparatus 100, ambient humidity of the display apparatus 100, luminance, a viewing distance of a viewer, a viewing time zone, the number of viewers, an eye direction of the viewer, a kind of content, and a viewing posture of the viewer.

The display apparatus determines a level of viewing concentration based on a sensing result of an external environment (S1410). The level of viewing concentration means a degree in which the viewer concentrates on an image displayed on the display apparatus 100. For example, when it is sensed that the viewer stares in a direction toward a front portion of the display apparatus 100 in a state in which an optimal indoor temperature and optimal indoor humidity are maintained, the display apparatus may determine that the level of viewing concentration is higher. Alternatively, when a kind of content is news or content, in which audio is emphasized as compared to video, such as content provided through an audio channel, the display apparatus may determine that the level of viewing concentration is lower. On the contrary, when a kind of content is a movie or sport content, the display apparatus may determine that the level of viewing concentration is higher.

The display apparatus displays the content by performing a power-saving processing operation at a level corresponding to the level of viewing concentration among a plurality of power-saving processing operation levels (S1415).

The power-saving processing operation may include at least one of, for example, an operation of performing display-off of an image frame in every preset period, an operation of turning off the super-resolution mode, an operation of reducing luminance, an operation of reducing a size of a display screen of the content, and an operation of turning on and/or off a display unit of the display apparatus.

According to an exemplary embodiment, the controller 130 may control the power-saving operation to be sequentially performed according to the level of viewing concentration. For example, when it is determined that the level of viewing concentration is higher, the display apparatus may not perform the power-saving processing operation, and when it is determined that the level of viewing concentration is reduced by about 10%, the display apparatus may turn off the super-resolution mode. Also, for example, when it is determined that the level of viewing concentration is reduced by about 20%, the display apparatus may perform display-off of an image frame in every 10 frame period.

According to the above-described various exemplary embodiments, without requiring the viewer to set a display apparatus to perform a power-saving processing operation according to change in the level of viewing concentration, the display apparatus may immediately determine the level of viewing concentration according to an external environment of the display apparatus to perform the power-saving processing operation.

The power-saving processing methods of a display apparatus according to the above-described various exemplary embodiments may be coded in software and stored in a non-transitory computer-recordable medium. The non-transitory computer-recordable medium may be mounted on various apparatuses and used.

As an example, a program code for performing operations of displaying content, sensing an external environment of the display apparatus, determining a level of viewing concentration based on a sensing result of the external environment, and displaying the content by performing a power-saving processing operation at a level corresponding to the level of viewing concentration among a plurality of power-saving processing operation levels may be stored in the non-transitory computer-recordable medium and provided. Further, the power-saving processing methods of a display apparatus according to the above-described various exemplary embodiments may be coded in a program and stored in the non-transitory computer-recordable medium.

The non-transitory computer-recordable medium is not a medium configured to temporarily store data such as a register, a cache, or a memory but an apparatus-readable medium configured to semi-permanently store data. Specifically, the non-transitory apparatus-readable medium may include, for example, a compact disc (CD), a digital versatile disc (DVD), a hard disc, a Blu-ray disc, a universal serial bus (USB), a memory card, or a read only memory (ROM).

According to the various exemplary embodiments, a display apparatus capable of performing a power-saving processing operation according to a level of viewing concentration of a viewer, and a power-saving processing method thereof may be provided.

The foregoing exemplary embodiments and advantages are merely exemplary and are not to be construed as limiting the present inventive concept. The exemplary embodiments can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A power-saving processing method, the method comprising:
sensing an external environment of a display apparatus;
determining a level of viewing concentration based on a result of the sensing; and
displaying content by performing a power-saving processing operation at a level corresponding to the level of viewing concentration among a plurality of levels of the power-saving processing operation.

2. The method as claimed in claim 1, wherein the sensing comprises imaging a viewer of the display apparatus, and
the level of viewing concentration is determined based on an imaged image of the viewer.

3. The method as claimed in claim 2, wherein the determining comprises:
determining a viewing posture of the viewer based on the imaged image of the viewer; and
determining the level of viewing concentration corresponding to the determined viewing posture of the viewer based on a plurality of pre-imaged images and information of a plurality of levels of viewing concentration set to match the plurality of images, respectively.

4. The method as claimed in claim 2, wherein the determining comprises:
determining an eye direction of the viewer based on the imaged image of the viewer;
calculating a direction of a location of the viewer relative to the display apparatus; and
comparing the eye direction with the direction of the location of the viewer and determining the level of viewing concentration according to a result of the comparison.

5. The method as claimed in claim 1, wherein the determining comprises:
calculating levels of viewing concentration of a plurality of viewers when the plurality of viewers are sensed; and
determining a total level of viewing concentration based on a number of viewers having levels of viewing concentration equal to or larger than a preset threshold value.

6. The method as claimed in claim 1, wherein the sensing comprises sensing a plurality of items of the external environment, and
the determining comprises:
acquiring sensing results of the plurality of items;
correcting the sensing results of the plurality of items by applying preset weights for the plurality of items to the sensing results; and
determining the level of viewing concentration based on the corrected sensing results.

7. The method as claimed in claim 6, wherein the plurality of items include at least one from among an ambient temperature of the display apparatus, an ambient humidity of the display apparatus, a luminance, a viewing distance of the viewer, a viewing time zone, a number of viewers, an eye direction of the viewer, and a viewing posture of the viewer.

8. The method as claimed in claim 1, wherein the power-saving processing operation comprises at least one from among an operation of performing display-off of an image frame in every preset period, an operation of turning off a super-resolution mode, an operation of reducing a luminance, an operation of reducing a size of a display area of the content, and an operation of turning on and/or off a display of the display apparatus.

9. The method as claimed in claim 1, wherein the displaying comprises controlling a display-off period of an image frame of the content according to the level of the viewing concentration.

10. A display apparatus, comprising:
a display configured to display content;
a sensor configured to sense an external environment of the display apparatus; and
a controller configured to determine a level of viewing concentration based on a result of the sensing, and control the display to display the content by performing a power-saving processing operation at a level corresponding to the level of viewing concentration among a plurality of levels of the power-saving processing operation.

11. The display apparatus as claimed in claim 10, wherein the sensor comprises a photographing unit configured to image a viewer of the display apparatus, and
the controller determines the level of viewing concentration based on an image of the viewer imaged through the photographing unit.

12. The display apparatus as claimed in claim 11, further comprising a storage,
wherein the controller determines a viewing posture of the viewer based on the imaged image of the viewer, and determines the level of viewing concentration corresponding to the determined viewing posture of the viewer based on a plurality of pre-imaged images stored in the storage and information of a plurality of levels of viewing concentration set to match the plurality of images, respectively.

13. The display apparatus as claimed in claim 11, wherein the controller determines an eye direction of the viewer based on the imaged image of the viewer, calculates a direction of a location of the viewer relative to the display apparatus, compares the eye direction with the direction of the location of the viewer, and determines the level of viewing concentration according to a result of comparison.

14. The display apparatus as claimed in claim 10, wherein the controller calculates levels of viewing concentration of a plurality of viewers when the plurality of viewers are sensed, and determines a total level of viewing concentration based on a number of viewers having levels of viewing concentration equal to or larger than a preset threshold value.

15. The display apparatus as claimed in claim 10, wherein the sensor senses a plurality of items of the external environment, and
the controller acquires sensing results of the plurality of items, corrects the sensing results of the plurality of items by applying preset weights for the plurality of items to the sensing results, and determines the level of viewing concentration based on the corrected sensing results.

16. The display apparatus as claimed in claim 15, wherein the plurality of items includes at least one from among an ambient temperature of the display apparatus, an ambient humidity of the display apparatus, a luminance, a viewing distance of the viewer, a viewing time period, a number of viewers, an eye direction of the viewer, and a viewing posture of the viewer.

17. The display apparatus as claimed in claim 10, wherein the controller performs the power-saving processing operation by performing at least one from among an operation of performing display-off of an image frame in every preset period, an operation of turning off a super-resolution mode, an operation of reducing a luminance, an operation of reducing a size of a display area of the content, and an operation of turning on and/or off the display of the display apparatus.

18. The display apparatus as claimed in claim 10, wherein the controller controls a display-off period of an image frame of the content according to the level of the viewing concentration.

19. The display apparatus as claimed in claim 10, wherein the controller determines a type of the content and performs the power-saving processing operation when the determined type of the content is a predetermined type.

20. A computer-readable recording medium having recorded thereon a program for executing the method of claim 1.
